(19) United States
(12) Patent Application Publication
(10) Pub. No.: US 2015/0269187 A1
(43) Pub. Date: Sep. 24, 2015

(54) APPARATUS AND METHOD FOR PROVIDING VIRTUAL MACHINE IMAGE FILE

(71) Applicant: Electronics and Telecommunications Research Institute, Daejeon (KR)

(72) Inventors: Jung Hyun CHO, Daejeon (KR); Seong Woon KIM, Gyeryong-si (KR); Sun Wook KIM, Hwaseong-si (KR); Dae Won KIM, Daejeon (KR); Soo Cheol OH, Daejeon (KR); Hag Young KIM, Daejeon (KR); Jong Bae MOON, Daejeon (KR); Myeong Hoon OH, Daejeon (KR)

(73) Assignee: Electronics and Telecommunications Research Institute, Daejeon (KR)

(21) Appl. No.: 14/664,399

(22) Filed: Mar. 20, 2015

(30) Foreign Application Priority Data
Mar. 20, 2014 (KR) 10-2014-0032801

(51) Int. Cl. G06F 17/30

(52) U.S. Cl. CPC G06F 17/30233; G06F 17/30194

(57) ABSTRACT

Provided is a method of providing a virtual machine image file in a cloud computing-based virtual desktop infrastructure. This method includes moving a golden image, an initial image provided from a shared storage, to a virtual machine driving server, converting the golden image into an image of a copy-on-write file format, and storing the same in a cache; allocating the converted virtual machine image to a virtual machine, and storing images of each virtual machine in the shared storage and managing the same to recover a virtual desktop when a disaster occurs. The method includes generating only data changed by the virtual machine, as a virtual machine image file, and managing the same, and hierarchically configuring a virtual machine image file based on a base image and storing the same in a cache memory in order to increase a loading rate of the virtual machine image file including the base image-based virtual machine image file.

### CROSS-REFERENCE TO RELATED APPLICATIONS

This application claims priority under 35 U.S.C. §119 to Korean Patent Application No. 10-2014-0032801, filed on Mar. 20, 2014, the disclosure of which is incorporated herein by reference in its entirety.

### TECHNICAL FIELD

The present invention relates to a method and apparatus for providing a virtual machine image file from a server.

### BACKGROUND

Desktop virtualization refers to a technique of generating virtual machines by a central server and allocating the virtual machines to users by managers and managing the same. That is, among virtual machine distribution techniques of desktop virtualization executed by a server providing a virtualization technique is a technique of providing a virtual machine image file of the same operating system to a plurality of virtual machines.

When virtual machines are executed (or driven) in a server, the server provides a screen and an interface to a user. The virtual desktop system of configuring a virtual desktop environment in a server and providing a service in a server-client form is known as a virtual desktop infrastructure (VDI).

When a virtual desktop environment is configured in the server, a virtual disk image including an operating system is allocated by virtual machine in order to support an independent virtual desktop environment. When a virtual machine is booted, a corresponding virtual machine image is loaded to perform an operation of reading or writing data required for starting a virtual desktop.

A virtual machine image format may be stored variously. Among virtual image formats are a raw image format in which an image size is determined by designated capacity and used and a Copy-On-Write-based format in which an image size equal to an actually used image size is used. The former is fast in space but occupies a large storage space, while the latter is effective in storage space but has low performance efficiency.

In such a VDI service environment, a method for supporting expandability according to an increase in users and virtual machines and storing and managing a virtual machine image to recover a server and virtual machine disaster is required. That is, a policy in which a host server, a virtual machine execution server, drives a virtual machine, a virtual machine image required therefor is stored in a network-based shared storage, and the host server and the network-based shared storage interwork with each other is required.

However, when such a policy is used, a virtual machine image file should be retrieved from the network-based shared storage each time a user request is made, degrading a data movement load and movement speed.

### SUMMARY

Accordingly, the present invention provides a method and apparatus for increasing a loading rate of a virtual image and reducing a movement load of a virtual machine image file by providing a virtual machine image file to a host server at a high speed in a server-based virtual desktop environment in order to support virtual desktop expandability and recovery in the event of a server disaster.

In one general aspect, a method of providing a virtual machine image file to a server of a cloud computing environment includes: converting a golden image provided from a network storage into an image of a copy-on-write file format; allocating the converted copy-on-write image to a virtual machine; and storing a base image and a virtual machine image file in a cache in order to increase a loading rate of the virtual machine image file including the base image and the virtual machine image file.

In another general aspect, a server for providing a virtual machine image file in a cloud computing environment, includes: a format converting unit configured to convert a golden image provided from a network storage into a copy-on-write image; an image file allocating unit configured to allocate the converted image to a common data sharing (base image)-based virtual machine; and an image file managing unit configured to manage only data changed by the virtual machine, as a virtual machine image file, and store the base image and the virtual machine image file based on the base image in a cache memory in order to increase a loading rate of the virtual machine image file including the base image and the image file.

Other features and aspects will be apparent from the following detailed description, the drawings, and the claims.

### BRIEF DESCRIPTION OF THE DRAWINGS

FIG. 1 is a view illustrating a cloud computing structure providing a virtual desktop infrastructure (VDI) service for practicing an embodiment of the present invention.

FIG. 2 is a block diagram schematically illustrating a virtual machine image processing system provided in a host server illustrated in FIG. 1.

FIGS. 3 through 5 are views illustrating a layout structure of a cache memory storing base image and virtual machine image files within a server according to an embodiment of the present invention.

FIG. 6 is a view illustrating a way in which a host server supports a certain host server when a disaster occurs in the certain host server.

FIG. 7 is a flow chart illustrating a method of providing a virtual machine image file according to an embodiment of the present invention.

### DETAILED DESCRIPTION OF EMBODIMENTS

The present invention supports expandability and disaster recovery as an image providing method of providing a virtual desktop service at a high speed in a server virtualization environment.

Hereinafter, embodiments of the present invention will be described in detail with reference to the accompanying drawings.

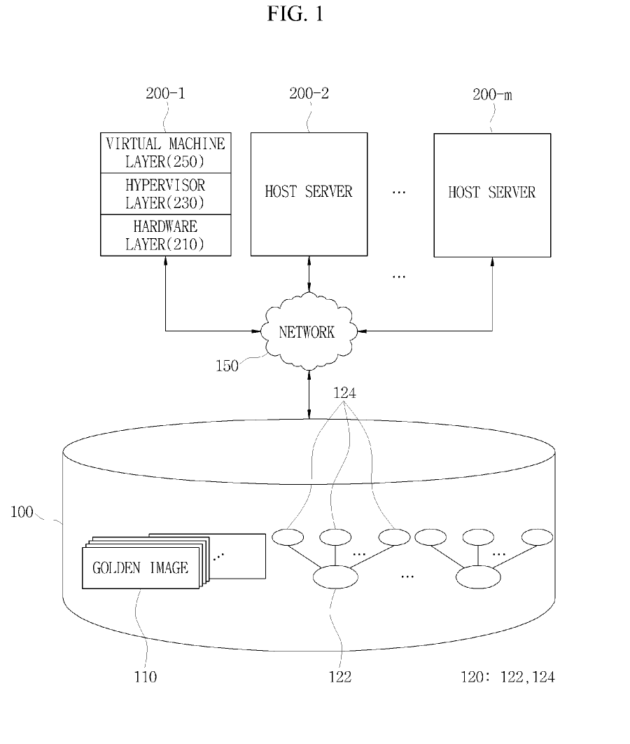

FIG. 1 is a view illustrating a cloud computing structure providing a virtual desktop infrastructure (VDI) service for practicing an embodiment of the present invention.

Referring to FIG. 1, a cloud computing structure (hereinafter, referred to as a “cloud computing structure”) providing a VDI service for practicing an embodiment of the present invention supports expandability and disaster recovery (DR) and also supports a fast loading speed of a virtual machine.

To this end, the cloud computing structure for practicing an embodiment of the present invention includes a network storage 100 storing a golden image file 110 (GOLDEN IMAGE-1) corresponding to an initial image of a virtual machine and a backup image file 120, and a plurality of host severs 200-1, 200-2, . . . , 200-m) connected to the network storage 100 through a network 150.

The network storage 100 provides the stored golden image through the network 150 according to a request from a certain host server. Also, the network storage 100 provides a backup image file 120 backed up by the certain host server according to a request from a designated substitute host server 200-1, 200-2, . . . , 200-m replacing a certain host server with a disaster. Here, the backup image file 120 includes one base image file 122 and a virtual machine image file 124 having only changed data of each virtual machine on the basis of the base image file 122.

In case of a virtual machine using a common operating system (OS) and a common application program, only one base image file and a changed virtual machine image file are moved from the network storage 100, significantly reducing a movement load and a required movement time of the backup image 120. That is, since the image file 124 including only one base image file 122 and changed data of each virtual machine moves to the substitute host server, a movement load and a required movement time may be considerably reduced.

When a user requests generation of a virtual machine, each of the plurality of host servers 200-1, 200-2, . . . , 200-m receives the golden image 110 from the network storage 100, changes the received golden image 110 into a copy-on-write format, and stores the same in a cache in order to support a fast loading rate.

Each host server 200-1, 200-2, . . . , 200-m basically includes a hardware layer 210, a hypervisor layer 230, and a virtual machine layer 250. The hardware layer 210, which is a central processing unit (CPU), a memory, a disk, an I/O device, and the like, is a layer representing physical resources. The hardware layer 210 communicates with the network storage 100 through the network 150. The hypervisor layer 230 virtualizes resources and devices of the hardware layer 210 and provides the same, and controls and arbitrates accessing the resources and devices. The hypervisor layer 230 generates execution environments of the virtual machines VM-1, VM-2, . . . , VM-n constituting the virtual machine layer 250. To this end, the hypervisor layer 230 controls loading and stopping of the virtual machines VM-1, VM-2, . . . , VM-n. The execution environments may be isolated by particular units such as partitions supported by the hypervisor layer 230. The virtual machines VM-1, VM-2, . . . , VM-n isolated by the particular units are mapped to physical resources according to a resource scheduling policy of the hypervisor layer 230.

The virtual machine layer 250 includes the plurality of virtual machines VM-1, VM-2, . . . , VM-n generated by the hypervisor layer 230. Although not shown, each of the virtual machines VM-1, VM-2, . . . , VM-n includes a guest O/S layer, an application layer, and a middleware layer.

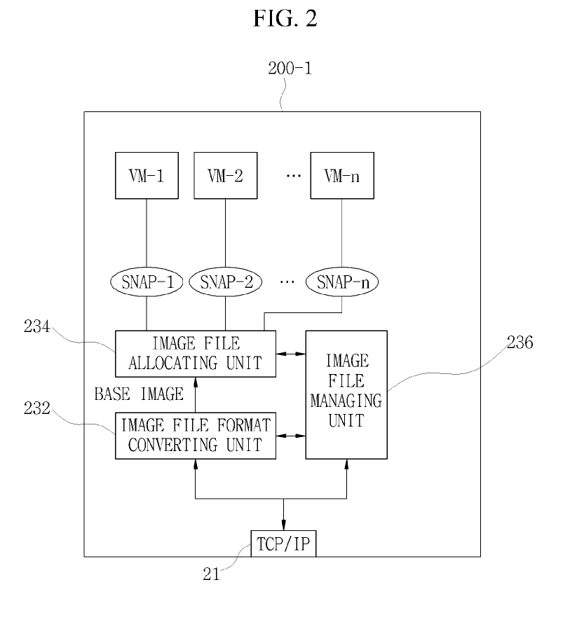

FIG. 2 is a block diagram schematically illustrating a virtual machine image processing system provided in a host server illustrated in FIG. 1.

Referring to FIG. 2, in order to enhance a loading rate of an image file provided from the network storage 100, the host server 200-1 includes an image file format converting unit 232 (hereinafter, referred to as a “format converting unit”), an image file allocating unit 234, and an image file managing unit 236. The components 232, 234, and 236 may belong to any one among the hardware layer 210, the hypervisor layer 230, and the virtual machine layer 250, and here, it is assumed that the components 232, 234, and 236 belong to the hypervisor layer 230.

The format converting unit 232 receives the golden image 110 from the network storage 100 through a TCP/IP network communication interface, and converts the received golden image 110 into one copy-on-write image file format dedicated for reading. As described above, a base image file is an image file including a basic OS and an environment setting commonly used in each virtual machine, which corresponds to a read-dedicated part.

Whenever a user requests generation of a virtual machine, the image allocating unit 234 allocates a base image file converted by the format converting unit 232 commonly to each virtual machine, stores contents changed by each virtual machine, as images files VM-1.img, VM-2.img, . . . , VM-n.img in a copy-on-write file format, and manages the same.

The image file managing unit 236 stores the base images and the plurality of virtual machine images respectively generated by the format converting unit 232 and the image allocating unit 234 in a cache storage device in order to enhance a loading rate.

The virtual machine image files are automatically backed up to the network storage 100 by the image file managing unit 236 according to a period designated by the user. When the virtual machine image files are generated based on the same base image, the virtual machine image files are moved to the network storage 100 only as much as changed data included in one base image and each virtual machine image file, reducing a movement load and a required movement time.

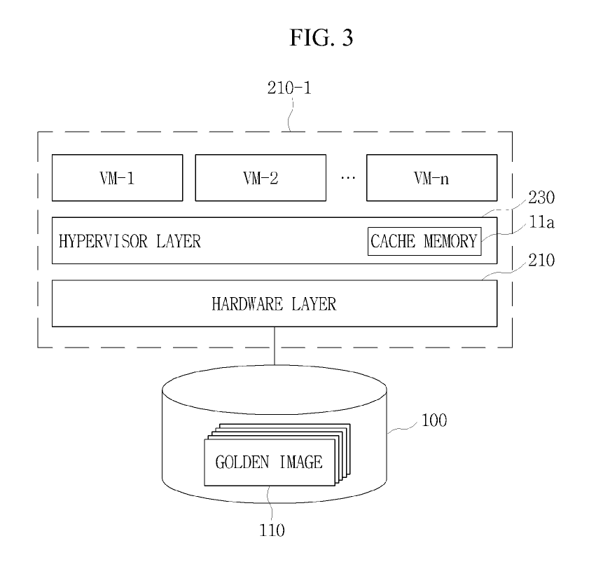

FIGS. 3 through 5 are views illustrating a layout structure of a cache memory storing base image-based virtual machine image files within a server according to an embodiment of the present invention.

As illustrated in FIG. 3, in a type in which the hypervisor layer 230 providing virtualization is present on the hardware layer 210, virtual machines VM-1, VM-2, . . . , VM-n are generated above the hypervisor layer 230, and the hypervisor layer 230 processes input/output though actual hardware, a cache memory is disposed in the hypervisor layer 230.

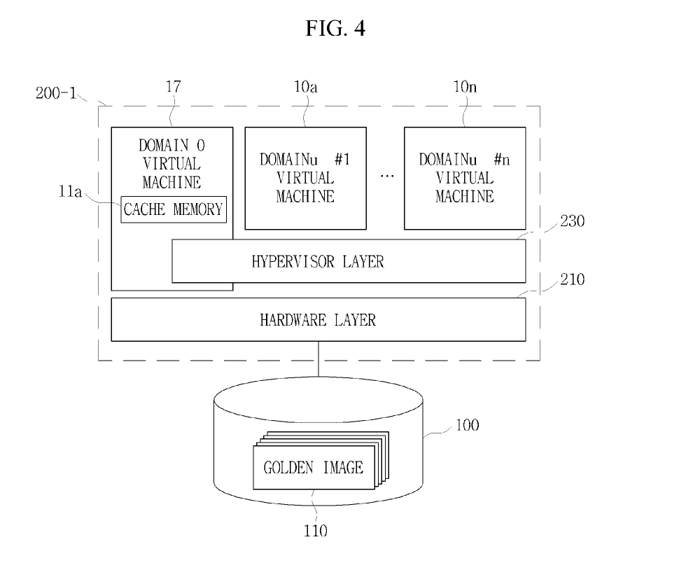

As illustrated in FIG. 4, in a type in which a particular virtual machine (domain 0 virtual machine) among virtual machines, rather than the hypervisor layer 230, processes device management and input/output, the cache memory 11a is positioned in the particular virtual machine.

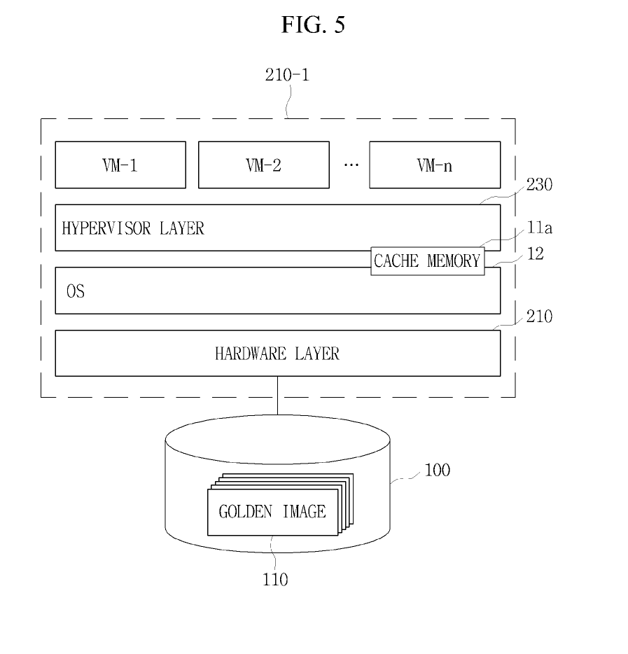

As illustrated in FIG. 5, in a type in which a general server OS 12 is present on the hardware layer 210, the hypervisor layer 230 is present thereabove, and virtual machines VM-1, VM-2, . . . , VM-are generated above the hypervisor layer 230, the cache memory 11a is positioned between the server OS 12 and the hypervisor layer 230.

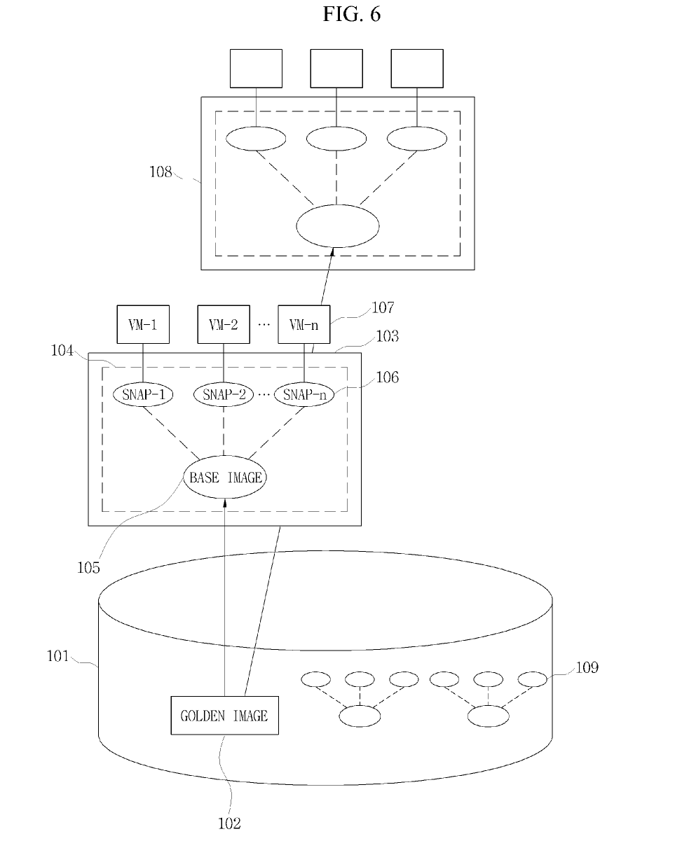

FIG. 6 is a view illustrating a way in which a host server supports a certain host server when a disaster occurs in the certain host server according to an embodiment of the present invention.

As illustrated in FIG. 6, the network storage 100 retains the golden image file 110 as an initial image for distributing a virtual machine. A certain host server 103 is a server driven by a virtual machine, and the network storage 100 is connected to the certain host server 103 by a network.

The golden image file 110 stored in the network storage 100 is transmitted to the certain host server 103 through the network 150 illustrated in FIG. 1, and the certain host server 103 changes the received golden image file 110 into a base image file 105 in a copy-on-write format. The virtual machines VM-1, VM-2, . . . , VM-n read the common base image file 105, and generate only contents changed while in use, as a virtual machine image file 106, individually. The generated image files are stored in a local cache 104 of the host server 103.

When a new host server is added to support expandability, the new host server is provided with the golden image, stored in the network storage 100, having the same structure as that of the virtual machine image file set in the certain host server 103, converts the received golden image into a virtual machine image on the basis of the copy-on-write image format, and stores the converted virtual machine image in a local cache thereof to enhance a loading rate. Thereafter, whenever generation of a virtual machine is requested, the new host server allocates an image to each virtual machine and manages the same.

The virtual machine image file generated by each host server is automatically backed up according to a period designated by the user. That is, with respect to a plurality of virtual machines being driven in each host server, the image files of the virtual machines are reconfigured to configure a backup image file 109 and stored in the network storage 100.

When full data backup is performed, a movement load and a required movement time are generated in proportion to the number of virtual machine images. However, in an embodiment of the present invention, since the images are stored in the copy-on-write format, only the common base image and the changed data of each virtual machine are moved, and thus, a load and a required time are reduced.

Thus, when a disaster occurs in a certain host server 103, the substitute host server 108 recovers the backup image file 109 stored in the network storage 101 and supports the same.

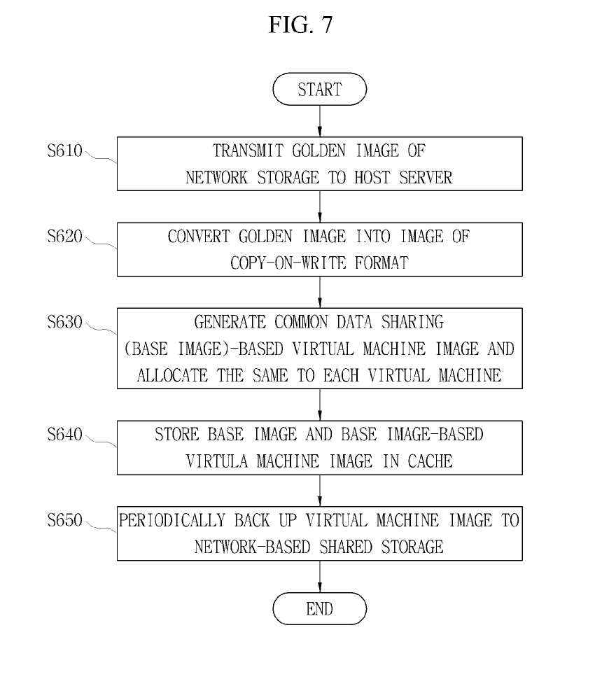

FIG. 7 is a flow chart illustrating a method of providing a virtual machine image file according to an embodiment of the present invention.

Referring to FIG. 7, first, the network storage transmits a stored golden image to a host server through a network according to a request from the host server in step S610.

The host server converts the golden image into a copy-on-write format in step S620.

The host server generates virtual machine images for each virtual machine on the basis of the image converted into the copy-on-write format, and allocates the generated virtual machine images to each virtual machine in step S630.

In order to enhance a loading rate, a base image and a virtual machine image based on the base image are stored in a cache in step S640, and the images for each virtual machine are reconfigured and periodically backed up to the network storage in step S640.

According to the present invention, while each virtual machine is being executed, part regarding read data is shared, only changed contents is configured as a virtual machine image file, and a base image corresponding to the configured read data and a virtual machine image are stored in a cache, thereby enhancing a loading rate of each virtual machine.

In order to back up files changed (or generated) by a virtual machine of each virtual machine execution server according to a period set by the user, base image files and virtual machine image files of each host server are stored in a network-based shared storage.

In this manner, when an error occurs in a certain host server, in order for a substitute host server to support disaster recovery of the certain host server, the base image and the virtual machine image stored in an image format in the network shared storage are moved to the substitute host server. Here, in the case of a virtual machine using a common OS and a common application program, only one base image and virtual machine image file data are moved, and thus, a load and required time due to movement can be reduced.

The present invention eventually proposes a method for supporting expandability and disaster recovery by utilizing a network shared storage, the present invention is effective to configure an environment for supporting a large-scale virtual desktop service.

Through the foregoing descriptions, a person skilled in the art may understand and realize the foregoing embodiments. In particular, the entirety or a portion of blocks of the method may be realized as relevant hardware instructed by a program. The program may be stored in a computer-readable storage medium. When the program is executed, one block or a combination thereof may be included in the embodiment of the method described above.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of providing a virtual machine image file to a server of a cloud computing environment, the method comprising:
converting a golden image provided from a network storage into an image of a copy-on-write file format;
allocating the converted copy-on-write image to a virtual machine; and
storing a base image and a virtual machine image file in a cache in order to increase a loading rate of the virtual machine image file including the base image and the virtual machine image file.

2. The method of claim 1, wherein the base image-based virtual machine image file has a copy-on-write format.

3. The method of claim 1, wherein the cache storage device is disposed in any one among a hypervisor layer, a domain 0 virtual machine among a plurality of virtual machines, an operating system layer, and a hypervisor layer.

4. The method of claim 1, further comprising:
periodically backing up the base image-based virtual machine image file configured hierarchically to the network storage.

5. A server for providing a virtual machine image file in a cloud computing environment, the server comprising:
a format converting unit for converting a golden image provided from a network storage into a copy-on-write image;
an image file allocating unit for allocating the converted image to a common data sharing (base image)-based virtual machine; and
an image file managing unit for managing only data changed by the virtual machine, as a virtual machine image file, and store the base image and the virtual machine image file based on the base image in a cache memory in order to increase a loading rate of the virtual machine image file including the base image and the image file.

6. The server of claim 5, wherein the base image-based virtual machine image file has a copy-on-write format.

7. The server of claim 5, wherein the cache storage device is disposed in any one among a hypervisor layer, a domain 0 virtual machine among a plurality of virtual machines, an operating system layer, and a hypervisor layer.

8. The server of claim 5, further comprising:
a network storage for periodically receiving the base image-based virtual machine image file configured hierarchically from the server to back up the virtual machine image file.
